(19) United States
(12) Patent Application Publication
(10) Pub. No.: US 2023/0162101 A1
(43) Pub. Date: May 25, 2023

(54) METHOD AND DEVICE FOR MULTI-STEP AHEAD PREDICTION OF TAXI-OUT TIME USING TIME SERIES FORECASTING

(71) Applicant: KOREA AEROSPACE RESEARCH INSTITUTE, Daejeon (KR)

(72) Inventors: Myeong Sook JEONG, Daejeon (KR); Yeon Ju EUN, Daejeon (KR); Dae Keun JEON, Daejeon (KR)

(21) Appl. No.: 17/986,354

(22) Filed: Nov. 14, 2022

(30) Foreign Application Priority Data
Nov. 24, 2021 (KR) 10-2021-0163108

(51) Int. Cl. G06Q 10/047; G06Q 10/0631

(52) U.S. Cl. CPC G06Q 10/047; G06Q 10/06311

(57) ABSTRACT

A method and device for predicting a multi-step ahead taxi-out time using time-series forecasting are provided. The method of predicting a multi-step ahead taxi-out time using time-series forecasting may include calculating an average taxi-out time that is time-invariant for an aircraft, calculating an additional taxi-out time that is time-variant for the aircraft, and predicting a multi-step ahead taxi-out time for the aircraft using the average taxi-out time and the additional taxi-out time.

### CROSS-REFERENCE TO RELATED APPLICATION

This application claims the benefit of Korean Patent Application No. 10-2021-0163108 filed on Nov. 24, 2021, in the Korean Intellectual Property Office, the entire disclosure of which is incorporated herein by reference for all purposes.

### BACKGROUND

### 1. Field of the Invention

Unlike the limitation of a conventional method that predicts a taxi-out time of an aircraft by considering airport congestion right before departure or near departure, the present disclosure provides a method and device for multi-step ahead taxi-out time prediction using time series forecasting that allows to predict a taxi-out time of an aircraft by considering airport congestion before departure of the aircraft (up to 2 hours before).

### 2. Description of the Related Art

Various planning tools for supporting various air traffic controls to alleviate problems of increased departure/arrival delays and decreased traffic efficiency due to an increase of air traffic require a model configured to predict a taxi-out time of each flight to calculate an optimized schedule of flights within limited resources.

The model configured to predict a taxi-out time may need to predict a taxi-out time by considering airport congestion from a point earlier (1 to 2 hours before) than the departure time of each flight.

A taxi-out time of an aircraft may vary even using the same taxi route depending on various dynamic variables, such as a type of aircraft, the number of arrival/departure flights moving on the airport ground, the runway configuration, the weather, and an airspace condition around the airport.

The dynamic variables may continuously and irregularly vary.

The existing models have predicted a taxi-out time of an aircraft by using methods, such as linear regression, fuzzy theory, queue theory, reinforcement learning, and given dynamic variable information right before the departure of the aircraft or near the departure time (15 minutes before departure).

Since an uncertainty of a dynamic variable required for predicting a taxi-out time of an aircraft is greater earlier before the departure time of the aircraft, the taxi-out time, of which uncertainty is removed as much as possible, considering airport congestion may be predicted right before the departure or near the departure.

Accordingly, existing models may have difficulty in directly applying a planning tool developed for an air traffic control support.

Therefore, there is a demand for an improved prediction model for relatively accurate prediction of a taxi-out time before the departure of an aircraft.

### SUMMARY

Example embodiments provide a method and device for predicting a multi-step ahead taxi-out time using time-series forecasting that may predict a taxi-out time of an aircraft by considering airport congestion before the departure of the aircraft.

According to an aspect, there is provided a method of predicting a multi-step ahead taxi-out time using time-series forecasting including calculating an average taxi-out time that is time-invariant for an aircraft, calculating an additional taxi-out time that is time-variant for the aircraft, and predicting a multi-step ahead taxi-out time for the aircraft using the average taxi-out time and the additional taxi-out time.

According to an aspect, there is provided a device for predicting a multi-step ahead taxi-out time using time-series forecasting including a first arithmetic unit configured to calculate an average taxi-out time that is time-invariant for an aircraft, a second arithmetic unit configured to calculate an additional taxi-out time that is time-variant for the aircraft, and a prediction unit configured to predict a multi-step ahead taxi-out time for the aircraft using the average taxi-out time and the additional taxi-out time.

Additional aspects of example embodiments will be set forth in part in the description which follows and, in part, will be apparent from the description, or may be learned by practice of the disclosure.

According to example embodiments, a method and device for predicting a multi-step ahead taxi-out time using time-series forecasting that may predict a taxi-out time of an aircraft by considering airport congestion before the departure of the aircraft may be provided.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a configuration of a device for multi-step ahead prediction of a taxi-out time using time-series forecasting, according to an example embodiment;

FIG. 2 is a diagram illustrating an example of a queue of aircrafts generated by airport congestion;

FIG. 3 is a diagram illustrating an example of multi-step ahead prediction of a taxi-out time by considering airport traffic;

FIG. 4 is a structure diagram illustrating a model for multi-step ahead prediction of a taxi-out time;

FIG. 5 is a diagram illustrating an example of a departure procedure of an aircraft;

FIGS. 6A and B are diagrams illustrating an example of an airport grid map and an average cell travel speed for each cell of the airport grid map;

FIG. 7 is a diagram illustrating an example of aircraft taxi-out;

FIGS. 8A and 8B are diagrams illustrating an example of a linear interpolation method; and

FIG. 9 is a flowchart illustrating a method of multi-step ahead prediction of a taxi-out time using time-series forecasting.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

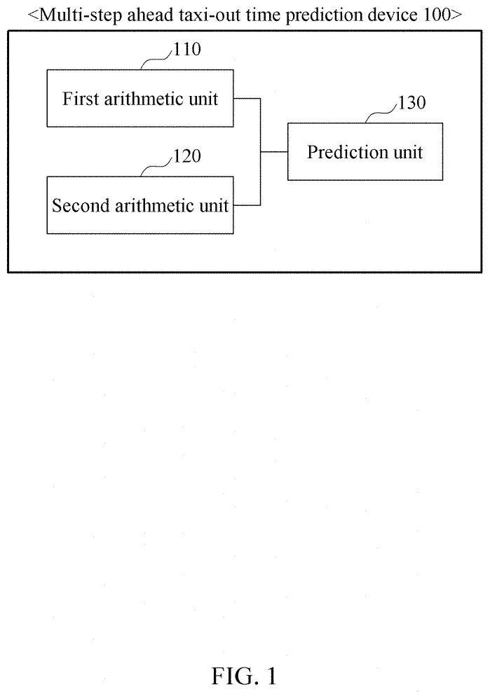

FIG. 1 is a block diagram illustrating a configuration of a device for multi-step ahead prediction of a taxi-out time using time-series forecasting, according to an example embodiment.

Referring to FIG. 1, a device for multi-step ahead prediction of a taxi-out time using time-series forecasting (hereinafter, referred to as the “multi-step ahead taxi-out time prediction device”) 100 may include a first arithmetic unit 110, a second arithmetic unit 120, and a prediction unit 130.

The first arithmetic unit 110 may calculate a time-invariant average taxi-out time for an aircraft. The first arithmetic unit 110 may calculate an average taxi-out time that does not change over time through an average taxi-out time prediction model.

The average taxi-out time may be a time taken by an aircraft to taxi-out along a taxi-route from pushback start (e.g., an aircraft is separated from a gate) to take-off roll.

When calculating the average taxi-out time, the first arithmetic unit 110 may calculate the average taxi-out time by calculating τ_{pushback} taken from pushback start of an aircraft carrying passengers to immediately before start of taxing and τₜₐₓᵢ taken from the start of taxing to takeoff

τ_{pushback} may be a time taken for moving an aircraft carrying passengers to a taxing start point by a towing car after the aircraft is separated from a gate and preparing taxing through acceleration of an aircraft engine at the taxing start point.

A start procedure of an aircraft may include: 1) the aircraft is separated from a gate to (gate off-block), 2) the aircraft is moved to a point where taxing is available by a towing car, 3) after the towing car withdraws, a pilot starts up the engine (i.e., an aircraft needs 3 to 5 minutes to start up the engine and reach required rpm(revolution per minute) to move), 4) the pilot requests a controller for taxi clearance through communication, 5) the controller accepts taxi clearance, 6) the aircraft starts taxing, 7) the aircraft moves through a taxiway and moves near the runway, 8) the pilot asks the controller to enter the runway, 9) when the controller approves entering the runway, the aircraft enters the runway and waits, 10) the pilot requests the controller for take-off, 11) the controller approves take-off, and 12) the pilot starts taking off.

In this departure procedure, τ_{pushback} may refer to time taken from 1) to 5), from gate off-block to acceptance of taxi clearance and τₜₐₓᵢ may refer to time taken from 6) to 12), from the start of aircraft taxing and to the start of take-off.

The first arithmetic unit 110 may calculate τ_{pushback} from the gate-off block time to taxi start time based on a departure gate of the aircraft and an aircraft type. The first arithmetic unit 110 may calculate τ_{pushback} that is constant in a predefined range by considering a departure gate designated for each aircraft and a time taken for engine acceleration for each aircraft type.

In addition, the first arithmetic unit 110 may calculate τₜₐₓᵢ taken from taxi start to take-off based on a taxi route of the aircraft and an airport grid map. The first arithmetic unit 110 may calculate τₜₐₓᵢ that is constant in a predefined range by considering a route to a runway for take-off and an airport grid map that displays the route on a grid map.

Then, the first arithmetic unit 110 may calculate an average taxi-out time τ_{average} by adding τ_{pushback} to τₜₐₓᵢ. The first arithmetic unit 110 may calculate the average taxi-out time from pushback start to take-off roll to be a sum of τ_{pushback} and τₜₐₓᵢ, which are individually calculated.

The second arithmetic unit 120 may calculate a time-variant additional taxi-out time for the aircraft. The second arithmetic unit 120 may calculate an additional taxi-out time that does not change over time through an additional taxi-out time prediction model.

The additional taxi-out time may be a variant time additionally taken for taxi-out of an aircraft due to a dynamic variable (e.g., the number of arrival/departure flights, the runway configuration, the weather, an airspace condition around an airport, etc.) that may be triggered during taxi-out of the aircraft.

When calculating the additional taxi-out time, the second arithmetic unit 120 may calculate the additional taxi-out time by a time value obtained by training by a long short-term model (LSTM).

The second arithmetic unit 120 may input a time of day, the number of departures, and the number of arrivals to the LSTM and may calculate the additional taxi-out time by a result output from the LSTM.

In this example, the time of day may be displayed from 0 to 24 hours. For example, when time-series data is obtained at one-hour intervals, the time of day may be input as 0, 1, 2, 3 to 23. In addition, the number of arrivals and the number of departures may be, for example, input by the number at 0:00, the number at 1:00, and the like.

In addition, the LSTM may be a learning model configured to compensate for a shortcoming of a recurrent neural network (RNN). The RNN has a problem that when a time step increases, information placed at the front may not be transmitted to the back, and to compensate for this, the LSTM may be configured by adding a cell state. The LSTM may remove an unnecessary memory by adding an input gate, a forget gate, and an output gate to a memory cell of a hidden layer and may store an item to remember.

The second arithmetic unit 120 may input aircraft information, which is the dynamic variable, to the LSTM and may calculate the additional taxi-out time by a time value output as a result from the LSTM through learning.

According to an embodiment, before inputting to the LSTM, the second arithmetic unit 120 may obtain time-series data by preprocessing aircraft information, which is the dynamic variable, such as a time of day, the number of departures, and the number of arrivals and may input the obtained time-series data to the LSTM.

Time of day information may be information on a surrounding environment of an airport and may include a weather condition by time, a runway condition, and a flying object (e.g., a flock of birds) in airspace.

The number of departures and the number of arrivals may refer to the number of arriving and departing aircrafts moving through the same runway and taxiway at a predetermined time.

The second arithmetic unit 120 may generate the time-series data through preprocessing the information and may learn by inputting the generated time-series data to the LSTM.

According to one embodiment, the second arithmetic unit 120 may more accurately calculate the additional taxi-out time by performing linear interpolation on an actual time for taxi-out of the aircraft.

For this, the second arithmetic unit 120 may satisfy Equation 6 Δτ_{actual}ⁱ=τ_{actual}ⁱ−τ_{average}ⁱ and may obtain a change Δτ_{actual}ⁱ of the actual additional taxi-out time of an aircraft i.

Here, τ_{actual}ⁱ may denote an actual taxi-out time of the aircraft i and τ_{average}ⁱ may denote a calculated average taxi-out time based on a departure gate of the aircraft i, an aircraft type, and a given taxi route.

The second arithmetic unit 120 may obtain the change Δτ_{actual}ⁱ by subtracting, from the average taxi-out time, the actual taxi-out time taken for taxi-out of the aircraft to move on the taxi route.

In addition, the second arithmetic unit 120 may obtain a linear interpolated value by sorting Δτ_{actual}ⁱ based on the departure time of the aircraft and performing linear interpolation at a predetermined time interval.

Linear interpolation may be a method of obtaining coordinates of a predetermined point between grid points by connecting two adjacent observation values in a straight line based on the assumption that the topography linearly changes.

The second arithmetic unit 120 may obtain more Δτ_{actual}ⁱ by performing linear interpolation on a pair of Δτ_{actual}ⁱ obtained at a predetermined time interval.

In addition, the second arithmetic unit 120 may calculate the additional taxi-out time by performing smoothing on the linear interpolated value by satisfying Equation 7

$${Δτ}_{smoothed} ( t ) = \frac{1}{5} {\sum }_{n = 0}^{4} {Δτ}_{interpolated} ( t - h \cdot k ) .$$

Here, Δτ_{smoothed}ⁱ may denote a smoothed additional taxi-out time, h may denote the number of steps in the past, and k may denote a time step size.

That is, the second arithmetic unit 120 may perform smoothing on a plurality of Δτ_{actual}ⁱ obtained through linear interpolation based on predefined Equation 7 and may calculate a final additional taxi-out time by the result of performing smoothing.

The prediction unit 130 may predict a multi-step ahead taxi-out time by using the average taxi-out time and the additional taxi-out time. The prediction unit 130 may accurately predict a multi-step ahead taxi-out time varying depending on a dynamic variable by adding a time-invariant average taxi-out time to a time-variant additional taxi-out time.

When predicting the multi-step ahead taxi-out time, the prediction unit 130 may predict the multi-step ahead taxi-out time of the aircraft by satisfying Equation 1 τ(t_{c}+Nₚ|t_{c})=τ_{average}+Δτ(t_{c}+Nₚ+t_{c}).

Here, τ(t_{c}+Nₚ/t_{c}) may denote a multi-step ahead taxi-out time at a time point t_{c}+Nₚ that is predicted at a time point t_{c}, τ_{average} may denote an average taxi-out time, Δτ(t_{c}+Nₚ/t_{c}) may denote an additional taxi-out time, and Nₚ may denote a prediction horizon having a range of 0 to 2 hours. The prediction unit 130 may predict and provide a final taxi-out time of an aircraft by considering airport congestion at least two hours before the departure by predicting a multi-step ahead taxi-out time by adding the average taxi-out time to the additional taxi-out time.

According to an embodiment, a method and device for predicting a multi-step ahead taxi-out time using time-series forecasting may be provided to predict a taxi-out time of an aircraft by considering airport congestion before the departure of the aircraft.

A conventional model for predicting a taxi-out time of an aircraft may predict the taxi-out time considering airport congestion only immediately before or near the departure time.

Accordingly, the conventional model for predicting a taxi-out time of an aircraft may have a problem that it may be difficult to directly apply the conventional model to a planning tool for supporting air traffic control that requires prediction information on a taxi-out time for each flight 1 to 2 hours before the departure.

The multi-step ahead taxi-out time prediction device 100 may provide a model configured to predict a taxi-out time of an aircraft by considering airport congestion 2 hours before the departure.

In the case of an airport, a delay may occur due to airport congestion when an aircraft throughput of the airport decreases due to a sudden increase in traffic because of limited resources or bad weather, such as heavy snowfall.

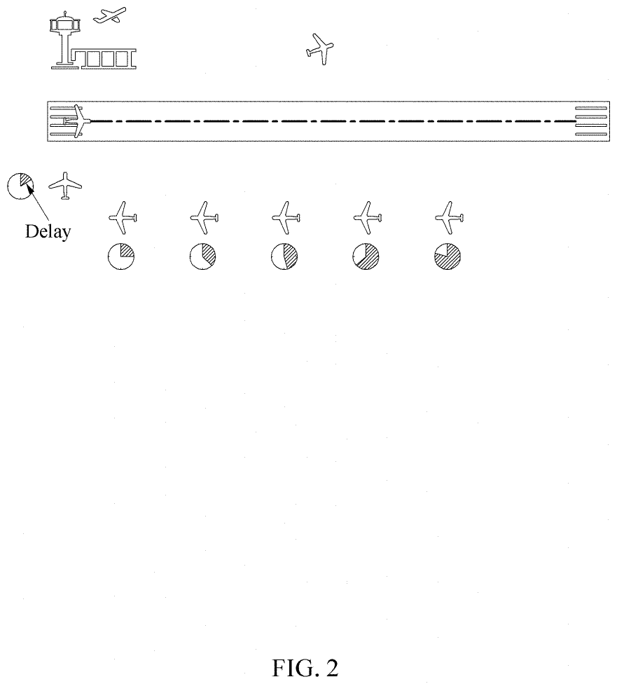

FIG. 2 is a diagram illustrating an example of a queue of aircrafts generated by airport congestion.

FIG. 2 illustrates an example that a departure queue is created near the runway.

As illustrated in FIG. 2, an aftereffect of a delay caused by a preceding flight may successively spread to following flights.

In other words, a delay occurring in the airport may affect not only one flight but also flights departing at a similar time.

In addition, once a delay occurs, the delay may not suddenly disappear but may gradually increase over time and then may be slowly relieved.

In addition, a flight departing late at night or early in the morning may experience less delay during taxing due to less traffic compared to a flight departing in the daytime.

That is, a delay element included in the taxi-out time of an aircraft may sensitively react to a change in airport congestion.

Airport congestion may be closely related to airport traffic.

The airport traffic may change with a predetermined trend over time, and the trend may be utilized as a tool for predicting the future by a trend of airport traffic changes in the past.

When a departure flight changes a departure time and moves along the same taxi-route to a takeoff runway from a gate, the taxi-out of the flight may vary depending on a change of airport congestion (e.g., an airport traffic change) at the departure time of the flight.

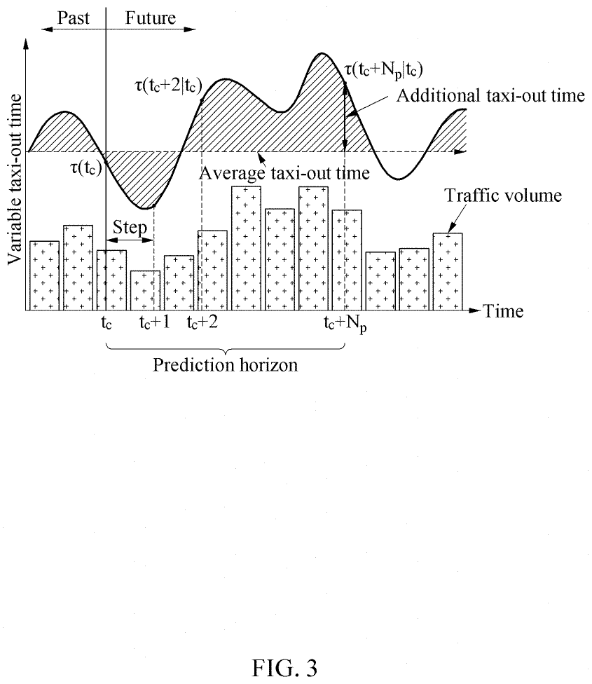

FIG. 3 is a diagram illustrating an example of multi-step ahead prediction of a taxi-out time by considering airport traffic.

Referring to FIG. 3, a bar may represent a traffic volume of an airport, a solid line may represent a taxi-out time that varies depending on a change of airport congestion (e.g., an airport traffic change) at a departure time of a flight.

Referring to FIG. 3, a broken line may represent an average taxi-out time in which an aircraft moves along a given taxi-route on average regardless of time.

The shaded part with diagonal lines of FIG. 3 may represent an additional taxi-out time that additionally increases or decreases, compared to the additional taxi-out time, depending on a change of airport congestion (e.g., an airport traffic change) that a flight using a predetermined taxi-route experiences on average.

t_{c} may denote a current time and Nₚ may denote a prediction horizon.

As shown in FIG. 3, a variable taxi-out time for each time point may be calculated by an additional taxi-out time for each time point to an average taxi-out time.

That is, when the average taxi-out time that is time-invariant is known, prediction of the variable taxi-out time may be relatively accurate by predicting the additional taxi-out time that is time-variant.

In addition, by learning a change trend of previous additional taxi-out times, prediction of an additional taxi-out time at a future time point, t_{c}+Nₚ, may be relatively accurate at a time point t_{c}.

Through this process, at the time point tc, the multi-step ahead taxi-out time prediction device 100 may predict a taxi-out time (e.g., a multi-step ahead taxi-out time) of an aircraft at the future time point t_{c}+Nₚ.

The multi-step ahead taxi-out time prediction device 100 may provide a method of predicting a taxi-out time 2 hours before departure of an aircraft by using an LSTM, which is one of time-series forecasting methods.

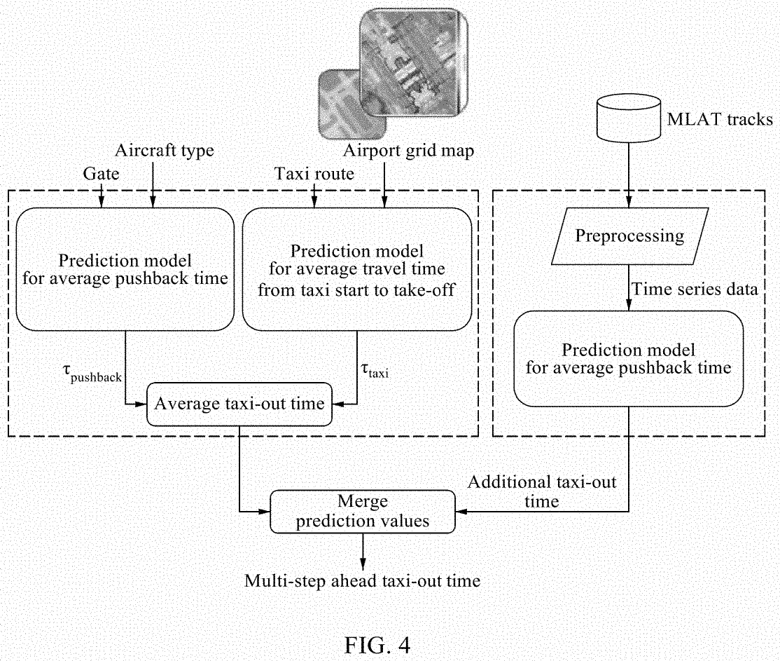

FIG. 4 is a structure diagram illustrating a model for multi-step ahead prediction of a taxi-out time.

FIG. 4 illustrates a structure of a model for predicting a multi-step ahead taxi-out time.

The model for predicting a multi-step ahead taxi-out time may be divided into a model (hereinafter, referred to as an average taxi-out time prediction model) for predicting a time-invariant average taxi-out time and a model (hereinafter, referred to as an additional taxi-out time prediction model) for predicting a time-variant additional taxi-out time.

The average taxi-out time prediction model may be further divided into a pushback time prediction model for predicting τ_{pushback} that is a time taken from gate off-block time of an aircraft to taxi start time and a taxi time prediction model for predicting τₜₐₓᵢ that is a time taken from taxi start time to take-off.

The pushback time prediction model may need a departure gate of each flight and an aircraft type as required inputs.

The taxi time prediction model may need a taxi route of each flight and an airport grid map for a surface travel speed of an aircraft as required inputs.

The additional taxi-out time prediction model may be configured to predict an additional taxi-out time before departure of a flight by receiving the time of day, the number of departure flights that are currently taxing in the airport, the number of arrival flights from multilateration wake turbulence, generating time series data by preprocessing them, and using them as an input of the LSTM.

A prediction value of the multi-step ahead taxi-out time may be expressed by Equation 1.

τ(t_{c}+Nₚ|t_{c})=τ_{average}+←τ(t_{c}+Nₚ+t_{c}) [Equation 1]

Here, τ(t_{c}+Nₚ/t_{c}) may denote a taxi-out time, which is predicted at a time point t_{c}, of a departure flight departing from a gate at a time point t_{c}+Nₚ.

τ_{average} may denote an average time from gate off-block to take-off of an individual flight.

Δτ(t_{c}+Nₚ/t_{c}) may denote an additional taxi-out time that is predicted at the time point t_{c} based on traffic of the airport surface.

Nₚ may denote a prediction horizon and may have a range between 0 to 2 (hours).

The model required for predicting a multi-step ahead taxi-out time may include the average taxi-out time prediction model and the additional taxi-out time prediction model.

First, the average taxi-out time prediction model may divide the average taxi-out time into two parts and be calculated based on Equation 2.

τ_{average}=τ_{pushback}+τ_{taxi,r} [Equation 2]

τ_{pushback} may denote a time from the gate off-block of an aircraft to before the start of actual taxing.

τ_{taxi,r} may denote an average time in which an aircraft starts taxing and moves along a taxi-route before take-off.

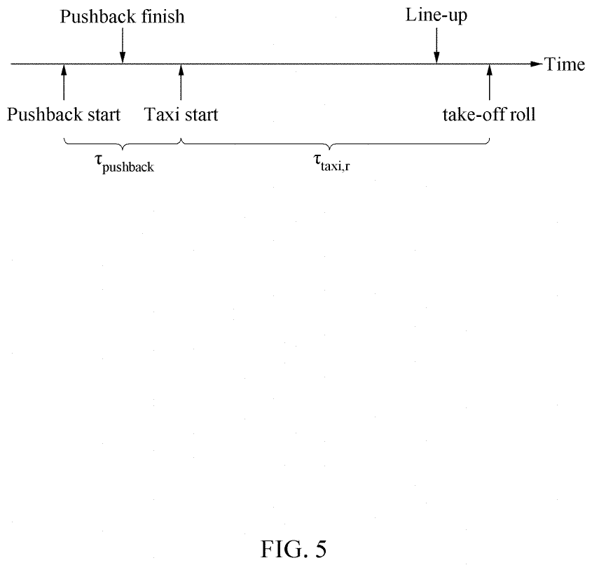

FIG. 5 is a diagram illustrating an example of a departure procedure of an aircraft.

Referring to FIG. 5, τ_{pushback} may denote a time from a pushback start in which an aircraft off-blocks from a gate, to a taxi start through pushback finish.

In addition, referring to FIG. 5, τ_{taxi,r} may denote a time from a taxi start in which an aircraft taxies to take-off roll through line-up.

τ_{pushback} may be calculated by Equation 3.

τ_{pushback}=τₚᵤₛₕ+τₛₜₒₚ [Equation 3]

τₚᵤₛₕ may denote a time taken by an aircraft to move from a gate to a taxi start point.

τₛₜₒₚ may denote a time taken by an aircraft to wait at the taxi start point until the start of an actual taxing.

In the multi-step taxi-out time prediction model, τₚᵤₛₕ may be set to an average pushback time for each gate and τₛₜₒₚ may be determined by a wake turbulence category (WTC) based on the aircraft type of a departure flight.

WTC may be divided into medium, heavy, and super heavy.

Equation 4 may be an equation expressing Equation 3 with WTC.

τ_{pushback}=X̅(Gate)+X̅(WTC)

τ_{taxi,r} may denote an average time of moving along a taxi route given to each flight.

Physically, as a taxi route increases, a taxi-out time also increases. However, even in case of the same distance, the taxi-out time may vary when passing through a region where a delay frequently occurs and a region where a delay does not frequently occur.

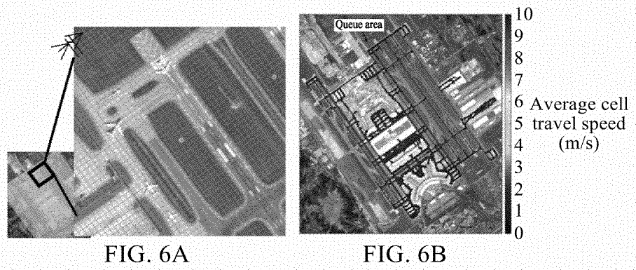

Accordingly, the multi-step ahead taxi-out time prediction device 100 may calculate τ_{taxi,r} using an airport grid map (refer to FIG. 6A) that divides an airport surface into a predetermined size of grids.

In addition, referring to FIG. 6B, the multi-step ahead taxi-out time prediction device 100 may calculate an average speed of an aircraft when passing through each cell of the airport grid map.

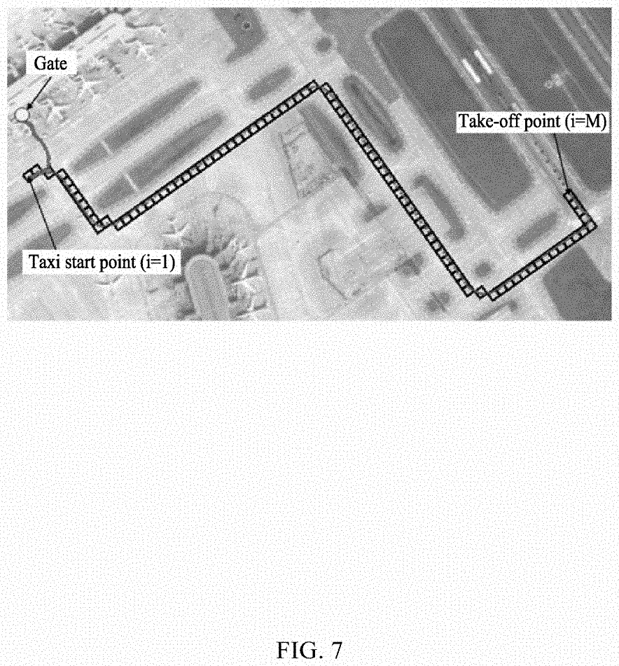

Referring to FIG. 7, finally, τ_{taxi,r} may be calculated by Equation 5 when an aircraft moves through M cells on the airport grid map.

$${τ}_{taxi , r} = {\sum }_{i = 1}^{M} \frac{d}{{v}_{i}} , i = 1 , 2 , 3 , … , M ( r ) \qquad [ Equation 5 ]$$

In Equation 5, d may denote a width of a cell and vi may denote an average cell moving speed of an i-th cell on the airport grid map.

FIGS. 6A and B are diagrams illustrating an example of an airport grid map and an average cell travel speed for each cell of the airport grid map.

FIG. 6A illustrates an example of an airport grid map that expresses an airport by dividing the entire airport into grids.

FIG. 6B illustrates an example of displaying a cell through which an aircraft may pass on the airport grid map of FIG. 6A by coloring the cell.

FIG. 7 is a diagram illustrating an example of aircraft taxi-out.

FIG. 7 shows cells through which an aircraft passes along a given taxi-route.

As illustrated in FIG. 7, the multi-step ahead taxi-out time prediction device 100 may display a taxi-route through which an aircraft may move by cells on an airport grid map.

The additional taxi-out time prediction model may be configured to predict an additional taxi-out time up to 2 hours after a current time point of an airport by using the LSTM.

The input of the LSTM model may be set to three types, which are the time of day, the number of departures, and the number of arrivals.

The output of the LSTM model may be the additional taxi-out time.

In this example, time steps of an input and an output may be variously set.

For an input to the additional taxi-out time, time series data may be obtained by periodically calculating the number of departures/arrivals currently taxing on the airport ground.

The multi-step ahead taxi-out time prediction device 100 may obtain an additional taxi-out time in a time-series form through the following three steps.

In step 1, the multi-step ahead taxi-out time prediction device 100 may obtain an actual additional taxi-out time for a flight i by Equation 6.

Δτ_{actual}ⁱ=τ_{actual}ⁱ−τ_{average}ⁱ [Equation 6]

τ_{actual}ⁱ may denote an actual taxi-out time of the flight i and τ_{average}ⁱ may denote an average taxi-out time calculated based on a departure gate, an aircraft type, and a given taxi route of the flight i.

In step 2, the multi-step ahead taxi-out time prediction device 100 may list Δτ_{actual}ⁱ extracted for an individual aircraft based on departure times of the individual aircraft and may obtain a linear interpolated value by performing linear interpolation at a predetermined time interval.

In step 3, the multi-step ahead taxi-out time prediction device 100 may perform smoothing on the linear interpolated value and obtain Δτ_{smoothed}ⁱ through Equation 7.

$${Δτ}_{smoothed} ( t ) = \frac{1}{5} {\sum }_{n = 0}^{4} {Δτ}_{interpolated} ( t - h \cdot k ) \qquad [ Equation 7 ]$$

Δτ_{smoothed}ⁱ may denote a smoothed additional taxi-out time, h may denote a previous step number, and k may denote a time step.

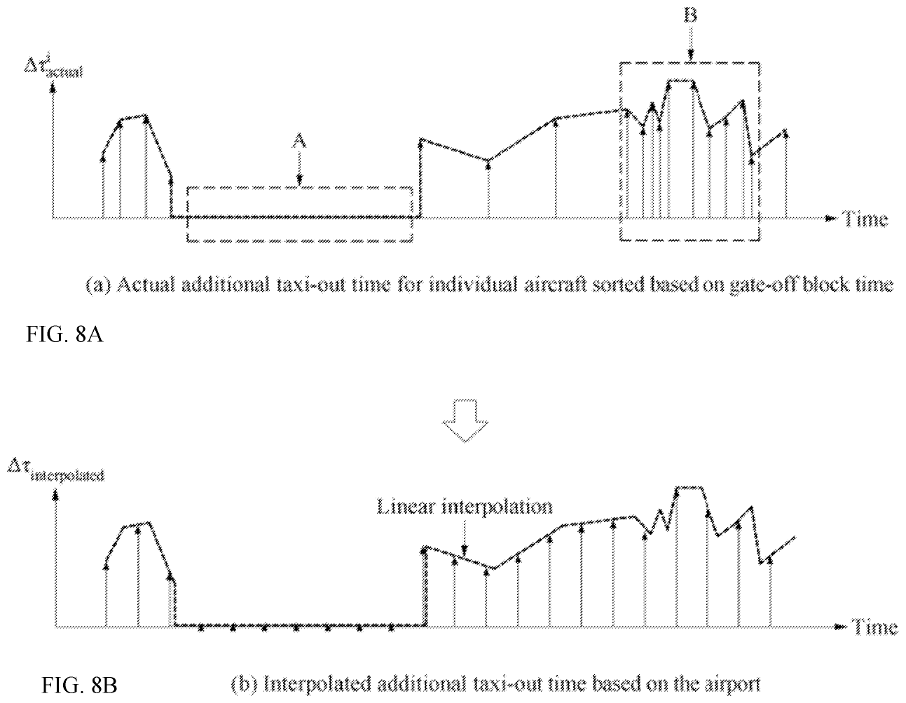

FIGS. 8A and 8B are diagrams illustrating an example of a linear interpolation method.

FIG. 8A shows actual additional taxi-out times for individual aircrafts sorted based on gate-off block time.

FIG. 8B shows an example of performing linear interpolation on the actual additional taxi-out time of FIG. 8A.

When the multi-step ahead taxi-out time prediction device 100 trains a model using the time of day and the numbers of departures and arrivals as inputs and using Δτ_{smoothed}ⁱ obtained for training an additional taxi-out time prediction model as an output, an additional taxi-out time (that is, a multi-step ahead prediction value) at a time point t_{c}+h as expressed by Equation 8.

F(t_{c}+1)=M(0(t_{c}), 0(t_{c}−1), 0(t_{c}−2), . . . , 0(t_{c}−(n)) [Equation 8]

To obtain a multi-step ahead prediction value using the LSTM, LSTM input information may be required as shown in Equation 9.

F(t_{c}+k·h)=Mₕ(0(t_{c}+k(h−1)), 0(t_{c}+k·(h−2)), . . . , 0(t_{c}−k·(n−h)) [Equation 9]

To predict a multi-step ahead additional taxi-out time two hours later based on the current time point tc, information on the time of day, the number of departures, and the number of arrivals for two hours from the current time point may be required.

The time of day may be easily calculated, however, the number of departures and the number of arrivals may be inaccurate.

Accordingly, the multi-step ahead taxi-out time prediction device 100 may use the number of departures and the number of arrivals of the same time of the day before based on tc as an input for multi-step ahead prediction.

Table 1 may show hyperparameters of the LSTM used by the additional taxi-out time prediction model.

TABLE 1

| Hyper-parameter item | settings |
|---|---|
| Input sequence length | 40 mins |
| Prediction horizon | 24 hours |
| Number of layers | 1 |
| Time step size | [0.5 min, 1 min, 2 min, |
| | 5 min, 10 min, 20 min] |
| Learning rate | 0.005 |
| Optimizer | Adam |
| Activation function | tanh |
| MaxEpochs | 250 |
| Batch size | 128 |
| Normalized function | Z-score |

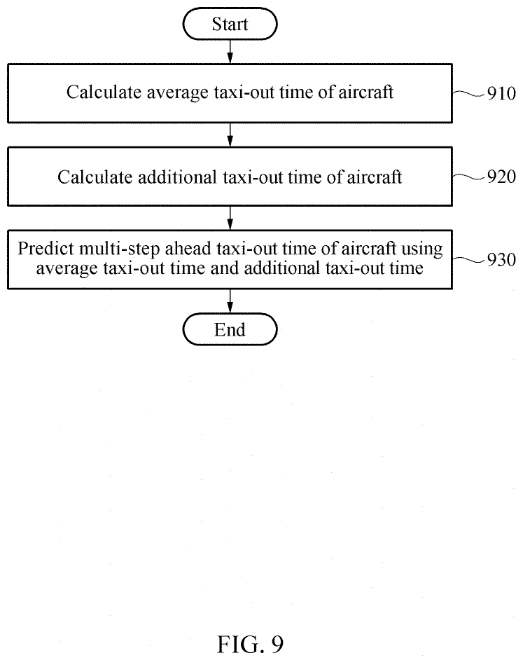

Hereinafter, an operation of the multi-step ahead taxi-out time prediction device 100 is described with reference to FIG. 9.

The method of predicting a multi-step ahead taxi-out time using time-series forecasting may be performed by the multi-step ahead taxi-out time prediction device 100.

FIG. 9 is a flowchart illustrating a method of multi-step ahead prediction of a taxi-out time using time-series forecasting.

In operation 910, the multi-step ahead taxi-out time prediction device 100 may calculate a time-invariant average taxi-out time for an aircraft. Operation 910 may be an operation of calculating time-invariant average taxi-out time through an average taxi-out time prediction model.

The average taxi-out time may be a time taken by an aircraft to taxi-out along a taxi-route from pushback start (e.g., an aircraft is separated from a gate) to take-off roll.

When calculating the average taxi-out time, the multi-step ahead taxi-out time prediction device 100 may calculate the average taxi-out time by calculating τ_{pushback} taken from pushback start of an aircraft carrying passengers to immediately before start of taxing and τₜₐₓᵢ taken from the start of taxing to takeoff

τ_{pushback} may be a time taken for moving an aircraft carrying passengers to a taxing start point by a towing car after the aircraft is separated from a gate and preparing taxing through acceleration of an aircraft engine at the taxing start point.

A start procedure of an aircraft may include: 1) the aircraft is separated from a gate (gate off-block), 2) the aircraft is moved to a point where taxing is available by a towing car, 3) after the towing car withdraws, a pilot starts up the engine (i.e., an aircraft needs 3 to 5 minutes to start up the engine and reach required rpm to move), 4) the pilot requests a controller for taxi clearance through communication, 5) the controller accepts taxi clearance, 6) the aircraft starts taxing, 7) the aircraft moves through a taxiway and moves near the runway, 8) the pilot asks the controller to enter the runway, 9) when the controller approves entering the runway, the aircraft enters the runway and waits, 10) the pilot requests the controller for take-off, 11) the controller approves take-off, and 12) the pilot starts taking off.

In this departure procedure, τ_{pushback} may refer to time taken from 1) to 5), from gate off-block to acceptance of taxi clearance and τₜₐₓᵢ may refer to time taken from 6) to 12), from the start of aircraft taxing and to the start of take-off.

The multi-step ahead taxi-out time prediction device 100 may calculate τ_{pushback} from the gate-off block time to taxi start time based on a departure gate of the aircraft and an aircraft type. The multi-step ahead taxi-out time prediction device 100 may calculate τ_{pushback} that is constant in a predefined range by considering a departure gate designated for each aircraft and a time taken for engine acceleration for each aircraft type.

In addition, the multi-step ahead taxi-out time prediction device 100 may calculate τₜₐₓᵢ taken from taxi start to take-off based on a taxi route of the aircraft and an airport grid map. The multi-step ahead taxi-out time prediction device 100 may calculate τₜₐₓᵢ that is constant in a predefined range by considering a route to a runway for take-off and an airport grid map that displays the route on a grid map.

Then, the multi-step ahead taxi-out time prediction device 100 may calculate an average taxi-out time τ_{average} by adding τ_{pushback} to τₜₐₓᵢ. The multi-step ahead taxi-out time prediction device 100 may calculate the average taxi-out time from pushback start to take-off roll to be a sum of τ_{pushback} and τₜₐₓᵢ, which are individually calculated.

In addition, in operation 920, the multi-step ahead taxi-out time prediction device 100 may calculate a time-variant additional taxi-out time for the aircraft. Operation 920 may an operation of calculating an additional taxi-out time that does not change over time through an additional taxi-out time prediction model.

The additional taxi-out time may be a variant time additionally taken for taxi-out of an aircraft due to a dynamic variable (e.g., the number of arrival/departure flights, the runway configuration, the weather, an airspace condition around an airport, etc.) that may be triggered during taxi-out of the aircraft.

When calculating the additional taxi-out time, the multi-step ahead taxi-out time prediction device 100 may calculate the additional taxi-out time by a time value obtained by training by the LSTM.

The multi-step ahead taxi-out time prediction device 100 may input a time of day, the number of departures, and the number of arrivals to the LSTM and may calculate the additional taxi-out time by a result output from the LSTM.

In this example, the time of day may be displayed from 0 to 24 hours. For example, when time-series data is obtained at one-hour intervals, the time of day may be input as 0, 1, 2, 3 to 23. In addition, the number of arrivals and the number of departures may be, for example, input by the number at 0:00, the number at 1:00, and the like.

In addition, the LSTM may be a learning model configured to compensate for a shortcoming of an RNN. The RNN has a problem that when a time step increases, information placed at the front may not be transmitted to the back, and to compensate for this, the LSTM may be configured by adding a cell state. The LSTM may remove an unnecessary memory by adding an input gate, a forget gate, and an output gate to a memory cell of a hidden layer and may store an item to remember.

The multi-step ahead taxi-out time prediction device 100 may input aircraft information, which is the dynamic variable, to the LSTM and may calculate the additional taxi-out time by a time value output as a result from the LSTM through learning.

According to an embodiment, before inputting to the LSTM, the multi-step ahead taxi-out time prediction device 100 may obtain time-series data by preprocessing aircraft information, which is the dynamic variable, such as a time of day, the number of departures, and the number of arrivals and may input the obtained time-series data to the LSTM.

The time of day information may be information on a surrounding environment of an airport and may include a weather condition by time, a runway condition, and a flying object (e.g., a flock of birds) in airspace.

The number of departures and the number of arrivals may refer to the number of arriving and departing aircrafts moving through the same runway and taxiway at a predetermined time.

The multi-step ahead taxi-out time prediction device 100 may generate the time-series data through preprocessing the information and may learn by inputting the generated time-series data to the LSTM.

According to one embodiment, the multi-step ahead taxi-out time prediction device 100 may more accurately calculate the additional taxi-out time by performing linear interpolation on an actual time for taxi-out of the aircraft.

For this, the multi-step ahead taxi-out time prediction device 100 may satisfy Equation 6 Δτ_{actual}ⁱ=τ_{actual}ⁱ−τ_{average}ⁱ and may obtain a change Δτ_{actual}ⁱ of the actual additional taxi-out time for an aircraft i.

Here, τ_{actual}ⁱ may denote an actual taxi-out time of the aircraft i and τ_{average}ⁱ may denote a calculated average taxi-out time based on a departure gate of the aircraft i, an aircraft type, and a given taxi route.

The multi-step ahead taxi-out time prediction device 100 may obtain the change Δτ_{actual}ⁱ by subtracting, from the average taxi-out time, the actual taxi-out time taken for taxi-out of the aircraft to move on the taxi route.

In addition, the multi-step ahead taxi-out time prediction device 100 may obtain a linear interpolated value by sorting Δτ_{actual}ⁱ based on the departure time of the aircraft and performing linear interpolation at a predetermined time interval.

Linear interpolation may be a method of obtaining coordinates of a predetermined point between grid points by connecting two adjacent observation values in a straight line based on the assumption that the topography linearly changes.

The multi-step ahead taxi-out time prediction device 100 may obtain more Δτ_{actual}ⁱ by performing linear interpolation on a pair of Δ96 _{actual}ⁱ obtained at a predetermined time interval.

In addition, the multi-step ahead taxi-out time prediction device 100 may calculate the additional taxi-out time by performing smoothing on the linear interpolated value by satisfying Equation 7

$${Δτ}_{smoothed} ( t ) = \frac{1}{5} {\sum }_{n = 0}^{4} {Δτ}_{interpolated} ( t - h \cdot k ) .$$

Here, Δτ_{smoothed}ⁱ may denote a smoothed additional taxi-out time, h may denote the number of steps in the past, and k may denote a time step size.

That is, the multi-step ahead taxi-out time prediction device 100 may perform smoothing on a plurality of Δτ_{actual}ⁱ obtained through linear interpolation based on predefined Equation 7 and may calculate a final additional taxi-out time by the result of performing smoothing.

In operation 930, the multi-step ahead taxi-out time prediction device 100 may predict a multi-step ahead taxi-out time by using the average taxi-out time and the additional taxi-out time. Operation 930 may be an operation of accurately predicting a multi-step ahead taxi-out time varying depending on a dynamic variable by adding a time-invariant average taxi-out time to a time-variant additional taxi-out time.

When predicting the multi-step ahead taxi-out time, the multi-step ahead taxi-out time prediction device 100 may predict the multi-step ahead taxi-out time of the aircraft by satisfying Equation 1 τ(t_{c}+Nₚ|t_{c})=τ_{average}+Δτ(t_{c}+Nₚ+t_{c}).

Here, τ(t_{c}+Nₚ/t_{c}) may denote a multi-step ahead taxi-out time at a time point t_{c}+Nₚ that is predicted at a time point t_{c}, τ_{average} may denote an average taxi-out time, Δτ(t_{c}+Nₚ/t_{c}) may denote an additional taxi-out time, and Nₚ may denote a prediction horizon having a range of 0 to 2 hours.

The multi-step ahead taxi-out time prediction device 100 may predict and provide a final taxi-out time of an aircraft by considering airport congestion at least two hours before the departure by predicting a multi-step ahead taxi-out time by adding the average taxi-out time to the additional taxi-out time. According to an embodiment, a method and device for predicting a multi-step ahead taxi-out time using time-series forecasting may be provided to predict a taxi-out time of an aircraft by considering airport congestion before the departure of the aircraft.

The method of predicting a multi-step ahead taxi-out time using time-series forecasting according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed method of predicting a multi-step ahead taxi-out time using time-series forecasting. The software and data may be stored by one or more non-transitory computer-readable recording mediums.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

What is claimed is:

1. A method of predicting a multi-step ahead taxi-out time using time-series forecasting, the method comprising:
calculating an average taxi-out time that is time-invariant for an aircraft;
calculating an additional taxi-out time that is time-variant for the aircraft; and
predicting a multi-step ahead taxi-out time for the aircraft using the average taxi-out time and the additional taxi-out time.

2. The method of claim 1, wherein the calculating of the average taxi-out time comprises:
calculating τ_{pushback} that is a time taken from a gate-off block time to a taxi start time based on a departure gate of the aircraft and a type of the aircraft;
calculating τₜₐₓᵢ that is a time taken from a taxi start time to take-off based on a taxi route of the aircraft and an airport grid map; and
calculating an average taxi-out time τ_{average} by adding the τ_{pushback} to the τₜₐₓᵢ.

3. The method of claim 1, wherein the calculating of the additional taxi-out time comprises:
inputting a time of day, a number of departure aircrafts, and a number of arrival aircrafts on an airport ground to a long short-term model (LSTM); and
calculating the additional taxi-out time by a result output from the LSTM.

4. The method of claim 3, wherein the inputting to the LSTM comprises
inputting time-series data obtained by preprocessing the time of day, the number of departure aircrafts, and the number of arrival aircrafts on the airport ground to the LSTM.

5. The method of claim 1, wherein the calculating of the additional taxi-out time comprises:
i) obtaining a change Δτ_{actual}ⁱ of actual additional taxi-out times for the aircraft i by satisfying Equation 6 Δτ_{actual}ⁱ=τ_{actual}−τ_{average},
wherein factual denotes an actual taxi-out time of the aircraft i and τ_{average}ⁱ denotes a calculated average taxi-out time based on a departure gate, an aircraft type, and a given taxi route of the aircraft i
ii) obtaining a linear interpolated value by sorting Δτ_{actual}ⁱ based on a departure time of the aircraft and performing linear interpolation at a predetermined time interval; and
iii) calculating the additional taxi-out time by performing smoothing on the linear interpolated value by satisfying Equation 7
$${Δτ}_{smoothed} ( t ) = \frac{1}{5} {\sum }_{n = 0}^{4} {Δτ}_{interpolated} ( t - h \cdot k ) ,$$
wherein Δτ_{smoothed}ⁱ denotes a smoothed additional taxi-out time, h denotes a number of previous steps, and k denotes a time step size.

6. The method of claim 1, wherein the predicting of the multi-step ahead taxi-out time comprises
predicting the multi-step ahead taxi-out time for the aircraft by satisfying Equation 1 τ(t_{c}+Nₚ|t_{c})=τ_{average}Δτ(t_{c}+Nₚ+t_{c}),
wherein the τ(t_{c}+Nₚ/_{c}e) denotes a multi-step ahead taxi-out time at a time point t_{c}+Nₚ that is predicted at a time point t_{c}, the τ_{average} denotes an average taxi-out time, Δτ(t_{c}+Nₚ/t_{c}) denotes an additional taxi-out time, and Nₚ denotes a prediction horizon having a range of 0 to 2 hours.

7. A device for predicting a multi-step ahead taxi-out time using time-series forecasting, the device comprising:
a first arithmetic unit configured to calculate an average taxi-out time that is time-invariant for an aircraft;
a second arithmetic unit configured to calculate an additional taxi-out time that is time-variant for the aircraft; and
a prediction unit configured to predict a multi-step ahead taxi-out time for the aircraft using the average taxi-out time and the additional taxi-out time.

8. The device of claim 7, wherein the first arithmetic unit is configured to:
calculate τ_{pushback} that is a time taken from a gate-off block time to a taxi start time based on a departure gate of the aircraft and a type of the aircraft,
calculate τₜₐₓᵢ that is a time taken from a taxi start time to take-off based on a taxi route of the aircraft and an airport grid map, and
calculate an average taxi-out time τ_{average} by adding the τ_{pushback} to the τₜₐₓᵢ.

9. The device of claim 7, wherein the second arithmetic unit is configured to:
input a time of day, a number of departure aircrafts, and a number of arrival aircrafts on an airport ground to a long short-term model (LSTM), and
calculate the additional taxi-out time by a result output from the LSTM.

10. The device of claim 9, wherein the second arithmetic unit is further configured to, before inputting to the LSTM, input time-series data obtained by preprocessing the time of day, the number of departure aircrafts, and the number of arrival aircrafts on the airport ground to the LSTM.

11. The device of claim 7, wherein the second arithmetic unit is configured to:
i) obtain a change Δτ_{actual}ⁱ of actual additional taxi-out times for the aircraft i by satisfying Equation 6 Δτ_{actual}ⁱ=τ_{actual}ⁱ−τ_{average}ⁱ,
wherein τ_{actual}ⁱ denotes an actual taxi-out time of the aircraft i and τ_{average}ⁱ denotes a calculated average taxi-out time based on a departure gate, an aircraft type, and a given taxi route of the aircraft i
ii) obtain a linear interpolated value by sorting Δτ_{actual}ⁱ based on a departure time of the aircraft and performing linear interpolation at a predetermined time interval, and
iii) calculate the additional taxi-out time by performing smoothing on the linear interpolated value by satisfying Equation 7
$${Δτ}_{smoothed} ( t ) = \frac{1}{5} {\sum }_{n = 0}^{4} {Δτ}_{interpolated} ( t - h \cdot k ) ,$$
wherein Δτ_{smoothed}ⁱ denotes a smoothed additional taxi-out time, h denotes a number of previous steps, and k denotes a time step size.

12. The device of claim 7, wherein the prediction unit is configured to
predict the multi-step ahead taxi-out time for the aircraft by satisfying Equation 1 τ(t_{c}+Nₚ|t_{c})=τ_{average}+Δτ(t_{c}+Nₚ+t_{c})
wherein τ(t_{c}+Nₚ/t_{c}) denotes a multi-step ahead taxi-out time at a time point t_{c}+Nₚ that is predicted at a time point t_{c}, τ_{average} denotes an average taxi-out time, Δτ(t_{c}+Nₚ/t_{c}) denotes an additional taxi-out time, and Nₚ denotes a prediction horizon having a range of 0 to 2 hours.

13. A non-transitory computer-readable storage medium storing instructions that, when executed by a processor, cause the processor to perform the method of claim 1.
